(19) United States
(12) Patent Application Publication
(10) Pub. No.: US 2013/0029239 A1
(43) Pub. Date: Jan. 31, 2013

(54) SHUTDOWN AND SELF-MAINTENANCE OPERATION PROCESS OF LIQUID FUEL CELL SYSTEM

(71) Applicants: Ku-Yen Kang, Hsinchu City (TW); Chun-Ho Tai, Hsinchu City (TW); Ching-Jung Liu, Hsinchu County (TW); Shou-Hung Ling, Taipei City (TW); Chung-Jen Chou, Yunlin County (TW); Yin-Wen Tsai, New Taipei City (TW)

(72) Inventors: Ku-Yen Kang, Hsinchu City (TW); Chun-Ho Tai, Hsinchu City (TW); Ching-Jung Liu, Hsinchu County (TW); Shou-Hung Ling, Taipei City (TW); Chung-Jen Chou, Yunlin County (TW); Yin-Wen Tsai, New Taipei City (TW)

(73) Assignee: INDUSTRIAL TECHNOLOGY RESEARCH INSTITUTE, Hsinchu (TW)

(21) Appl. No.: 13/346,678

(22) Filed: Jan. 9, 2012

(30) Foreign Application Priority Data
Jul. 29, 2011 (TW) 100127061

(51) Int. Cl. H01M 8/04

(52) U.S. Cl. 429/429

(57) ABSTRACT

A shutdown and self-maintenance operation process of a liquid fuel cell system is introduced. The liquid fuel cell system gives out a shutdown signal and a liquid fuel cell of the liquid fuel cell system stops discharging when receiving the shutdown signal. Thereafter, a self-maintenance operation consisting of the following four steps will be performed: (a) Supply of the cathode gas is stopped in the liquid fuel cell system. (b) After a first duration, the supply of the cathode gas is started. (c) The liquid fuel cell discharges until the output power of the liquid fuel cell is less than or equal to a first predetermined value. (d) The liquid fuel cell stops discharging and the supply of the cathode gas is stopped again. The (a) to (d) four steps are repeated several times before the liquid fuel cell system is completely stopped.

### CROSS-REFERENCE TO RELATED APPLICATION

This application claims the priority benefit of Taiwan application serial no. 100127061, filed on Jul. 29, 2011. The entirety of the above-mentioned patent application is hereby incorporated by reference herein and made a part of this specification.

### TECHNICAL FIELD

The disclosure relates to a shutdown and self-maintenance operation process of a liquid fuel cell system.

### BACKGROUND

Fuel cells are an alternative for conventional energy. Basically, fuel cells can be categorized into gas fuel cells and liquid fuel cells depending on the fuels therein. Here, direct methanol fuel cells (DMFCs) are the most popular liquid fuel cells right now. DMFCs adopt methanol solutions directly as a fuel supply source and generate a current from a related electrode reaction of methanol and oxygen.

When a DMFC system is shut down, the methanol fuel remains at the anode side. In a bipolar channel, conventionally, the supply of the anode fuel is stopped after the shut down, and the cathode gas is supplied continuously for a period of time so as to consume the methanol fuel crossed over to the cathode. However, this only prevents the toxication of the cathode by the methanol fuel in the early period of shutting down. After the supply of the cathode gas is stopped, the fuel not yet reacted then reaches the cathode to toxicate the cathode catalyst.

On the other hand, when a passive liquid fuel cell system with a higher concentration is used, the fuel concentration at the anode accumulates continuously after the shut down and the anode fuel crosses over to the cathode. If the remaining fuel is not processed within a certain time after the shut down, the cathode catalyst may be easily toxified.

Therefore, solutions proposed to solve the above issues have been disclosed recently. For example, in terms of active fuel cell systems, Taiwan Patent No. TW I315109 proposed that when the fuel cell system is shut down, the anode fuel stops the supply cycle and the cathode fan continuous to operate until the difference between the temperature of the fuel cell system and the external temperature is smaller than the set value. In China Patent No. CN1996655, it is disclosed that when the system is shut down, the supply of the high concentration fuel at the anode is stopped, but the pump for transporting the low concentration fuel continues to transport the fuel in the fuel mixing tank to the anode side until the mixing fuel concentration is equal to or lower than the set concentration. The methods aforementioned try to consume the methanol fuels at the anodes as much as possible to prevent the remaining fuel from toxicating the cathode catalyst, thereby affecting the lifespan of the fuel cell.

However, the technique provided in the current technology includes keeping the fuel concentration or the fuel level at the anode side under a certain level, which is quite different from the ideal situation of having no methanol remaining. This is due to the fact that the shutdown process is a power consuming process which must be carried out using the electric power stored in the secondary battery inside the fuel cell system. The shutdown process thus can not be too long. Although the current technique is capable of keeping the fuel concentration or fuel level at the anode side under a certain level, when the supply of the cathode gas is stopped, the methanol remaining at the anode side still accumulates at the cathode through the crossover path so as to result in cathode catalyst toxication.

In another liquid fuel cell system, the fuel required by the anode is provided through the evaporation gas of the liquid-state high concentration methanol. When this system is shutdown, the high concentration methanol continues to evaporate into gas. Therefore, even though the system is shutdown, the methanol fuel in the anode continues to accumulate, thereby causing the resistance increase in the electrolyte membrane and the cathode catalyst toxication. In Japan Patent No. JP2007-173110, a valve for shielding a gaseous-state fuel is disposed in the anode fuel supply region, wherein the valve can be closed when the system is shutdown. Nevertheless, in the actual system, the range of supplying the gaseous-state fuel to the anode is wide, equal to the area of the membrane electrode assembly. The disposition of the valve not only occupies the system volume, but makes it difficult for enclosing the wide range gaseous-state fuel diffusion in implementation.

### SUMMARY

A shutdown and self-maintenance operation process of a liquid fuel cell system is introduced herein. The process includes the following. The liquid fuel cell system gives a shutdown signal and a liquid fuel cell of the liquid fuel cell system stops discharging when receiving the shutdown signal. Further steps a to d are then performed. Step a: The liquid fuel cell system stops supplying a cathode gas. Step b: After a first duration, the liquid fuel cell system starts supplying the cathode gas. Step c: The liquid fuel cell starts discharging until an output power of the liquid fuel cell is less than or equal to a first predetermined value. Step d: The liquid fuel cell stops discharging and stops supplying the cathode gas. The duration between starting to supply the cathode gas at step b and stopping to supply the cathode gas at step d is defined as a second duration. Steps a to d are repeated until a total output power of the liquid fuel cell in the second duration is smaller than or equal to a second predetermined value or until a cycle of repeating steps a to d has reached a predetermined number of times. The liquid fuel cell system is then stopped completely.

A shutdown and self-maintenance operation process of a liquid fuel cell system is introduced herein. The process includes the following. A shutdown signal is given to the liquid fuel cell system and when the liquid fuel cell system receives the shutdown signal, a liquid fuel cell of the liquid fuel cell system stops discharging and stops supplying an anode fuel. Afterwards, a supply of a cathode gas is stopped for a first duration and the cathode gas is supplied for a second duration. The two steps of stopping to supply the cathode gas in the first duration and starting to supply the cathode gas again in the second duration are repeated. The liquid fuel cell system is stopped completely.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a sketch block diagram illustrating a liquid fuel cell system according to a first exemplary embodiment.

FIG. 2 is a flowchart illustrating steps for shutting down a liquid fuel cell system according to the first exemplary embodiment.

FIG. 3 is a curve diagram illustrating time versus discharging level of the steps for shutting down according to the first exemplary embodiment.

FIG. 4 is a sketch block diagram illustrating a liquid fuel cell system according to a second exemplary embodiment.

FIG. 5 is a flowchart illustrating steps for shutting down a liquid fuel cell system according to the second exemplary embodiment.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

### DETAILED DESCRIPTION OF DISCLOSED EMBODIMENTS

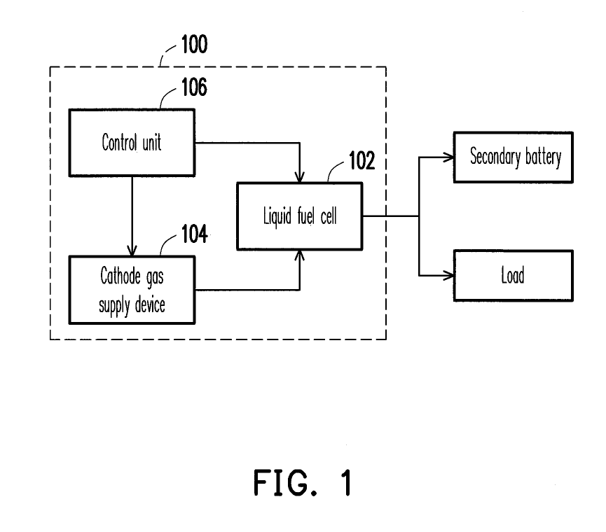

FIG. 1 is a sketch block diagram illustrating a liquid fuel cell system according to a first exemplary embodiment. Herein, only several main elements in a conventional liquid fuel cell system are shown. In FIG. 1, the liquid fuel cell system 100 includes a liquid fuel cell 102, a cathode gas supply device 104, and a control unit 106. The control unit 106 controls the discharging of the liquid fuel cell 102 and controls the gas supply from the cathode gas supply device 104 to the liquid fuel cell 102. The electric power discharged from the liquid fuel cell 102 can be stored in a secondary battery or supplied to a load.

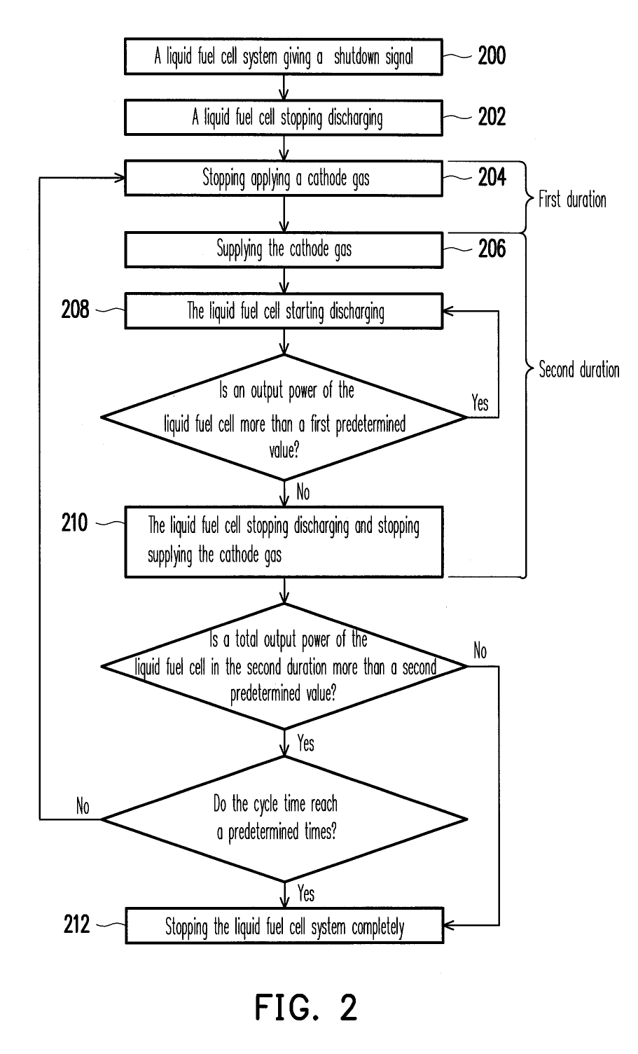

FIG. 2 is a flowchart illustrating steps for shutting down a liquid fuel cell system according to the first exemplary embodiment. Referring to FIG. 2 and FIG. 1 simultaneously in the following to understand the shutdown process of the system.

Firstly, the liquid fuel cell system 100 gives a shutdown signal as shown in step 200. The shutdown signal is, for example, a shutdown signal given from the control unit 106 of the liquid fuel cell system 100 when a discharging level of the liquid fuel cell 102 is lower than a set value (which can be more than or equal to a total power consumption level of the liquid fuel cell system 100).

In step 202, when the liquid fuel cell 102 receives the shutdown signal, the liquid fuel cell 102 stops discharging.

In step 204, the liquid fuel cell system 100 stops supplying a cathode gas for a first duration. In this step, for example, the shutdown signal given from the control unit 106 also reaches the cathode gas supply device 104, such that the cathode gas supply device 104 stops supplying the cathode gas.

Step 204 can be performed simultaneously with or several seconds after step 202.

Then, after the first duration, the cathode gas is supplied for a second duration in step 206. The first duration ranges, for example, from 5 seconds (s) to 1 hour (hr). The length of the first duration is related to the amount of the anode fuel remained. Generally, the more the anode fuel remains, the shorter the first duration is. The first duration ranges favorably from 10 s to 30 minutes (min).

In step 208, the liquid fuel cell 102 discharged and the electric power discharged from the liquid fuel cell 102 can be stored in the secondary battery or supplied to a load (as shown in FIG. 1). Step 208 can be performed simultaneously with or several seconds after step 206. During step 208, when an output power of the liquid fuel cell 102 is more than a first predetermined value, then the liquid fuel cell 102 continues to discharge; when the output power of the liquid fuel cell 102 is less than or equal to the first predetermined value, then step 210 is subsequently executed.

In step 210, the liquid fuel cell 102 stops discharging and stops providing the cathode gas. The second duration is a duration between starting to provide the cathode gas at step 206 and stopping to provide the cathode gas at step 210. The first predetermined value is a power consumption of the liquid fuel cell system 100 itself, for instance.

Thereafter, steps 204 to 210 are repeated. In a cycle of repeating steps 204 to 210, the first duration is a constant or a value changing with a temperature variation of the liquid fuel cell 102, wherein the temperature variation is a difference between an environmental temperature and a temperature of the liquid fuel cell 102. For example, the environmental temperature can be a fixed parameter and the temperature of the liquid fuel cell 102 can be a comparative parameter, and the first duration becomes longer as said difference between the temperatures becomes smaller. Moreover, the first duration can also be a value changing along with a variation in the output power of the liquid fuel cell 102 in the second duration, wherein the output power variation is a difference obtained by deducting a power output in previous second duration from a power output in present second duration. For example, when the output power of the liquid fuel cell 102 in the second duration of this cycle is less than the output power in the second duration of previous cycle, the anode methanol fuel then has less amount remaining and the first duration can be longer.

Step 212 is performed when a total output power of the liquid fuel cell 102 in the second duration is less than or equal to a second predetermined value or the cycle time of repeating steps 204 to 210 has reached a predetermined times. In step 212, the liquid fuel cell system 100 is stopped completely. The second predetermined value is, for example, a total power consumption of the liquid fuel cell system 100 in the first duration and the second duration. The predetermined times range from 1 to 20 times, preferably from 1 to 12 times; however, the present exemplary embodiment is not limited thereto.

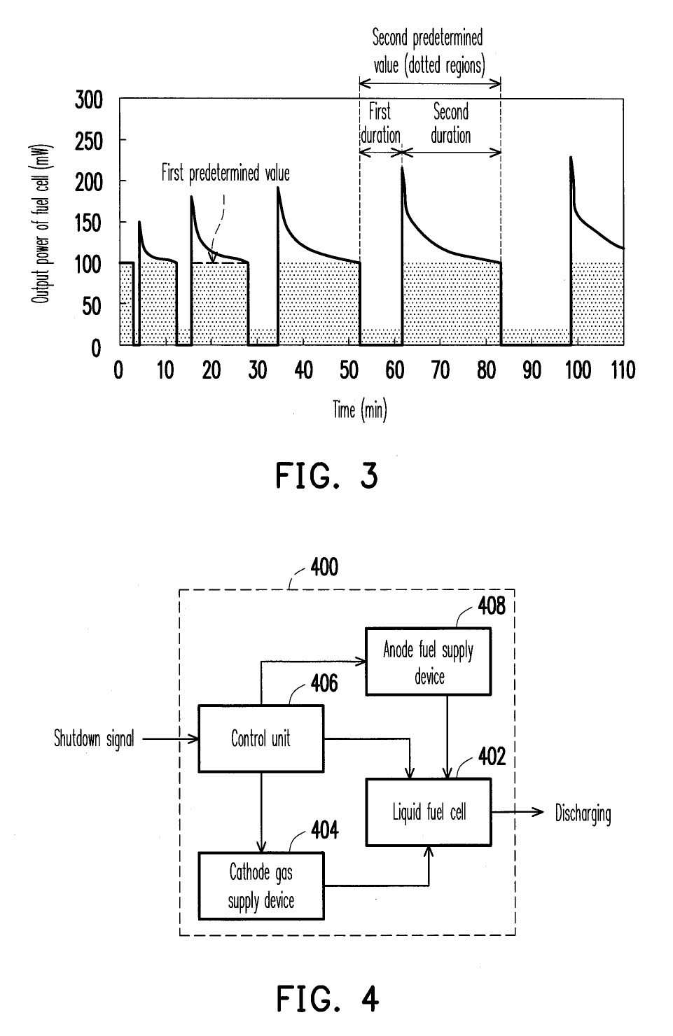

FIG. 3 is a curve diagram illustrating time versus discharging level of the steps for shutting down according to the first exemplary embodiment. Assuming the total power consumption of the liquid fuel cell system 100 is 100 mW and a time of stopping the discharge of liquid fuel cell 102 is set to be having a discharging level lower than 100 mW, when the cathode gas supply device 104 stops supplying the cathode gas, the total power consumption of the liquid fuel cell system 100 decreases to lower than 20 mW. As depicted in FIG. 3, the first predetermined value is 100 mW and the second predetermined value is the total power consumption of the system in the first duration and the second duration (that is, a total amount of dotted regions). With the number of times for repeating the steps of stopping supplying the cathode gas and supplying the cathode gas increases, the duration between the first durations becomes longer from 1 min, 3 min, 5 min, 10 min, to more than 15 min gradually. After receiving the shutdown signal, the liquid fuel cell can still discharge intermittently until the fuel is consumed completely. The method of the present exemplary embodiment thus not only prevents the unfavorable influence of the remaining anode fuel to the membrane electrode, but also enhances the utilization rate of the fuel.

FIG. 4 is a sketch block diagram illustrating a liquid fuel cell system according to a second exemplary embodiment. Herein, only several main elements in a conventional liquid fuel cell system are shown. In FIG. 4, the liquid fuel cell system 400 includes a liquid fuel cell 402, a cathode gas supply device 404, a control unit 406, and an anode fuel supply device 408. The control unit 406 receives an external signal to control the discharging of the liquid fuel cell 402 and control whether the cathode gas supply device 404 and the anode fuel supply device 408 supply gas or fuel to the liquid fuel cell 402 or not, respectively.

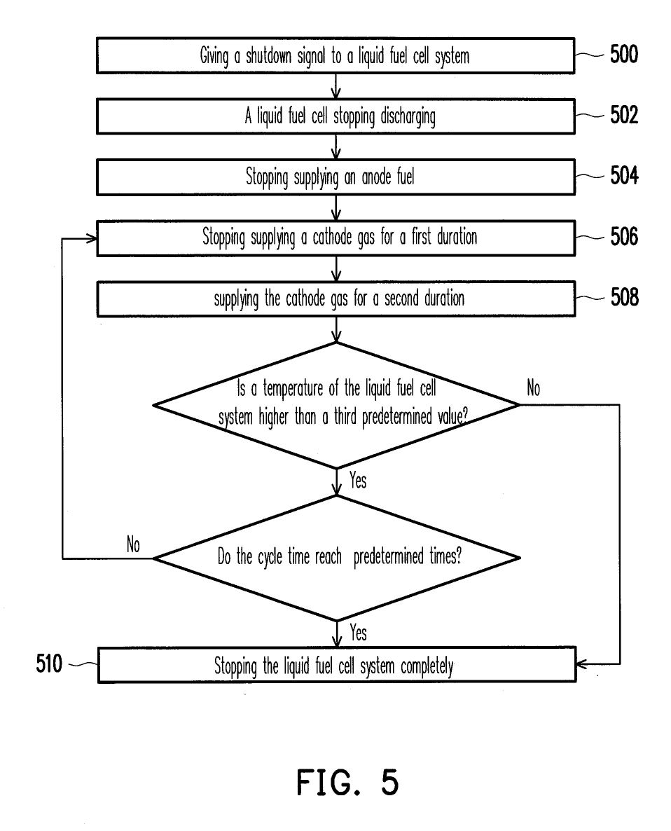

FIG. 5 is a flowchart illustrating steps for shutting down a liquid fuel cell system according to the second exemplary embodiment. Referring to FIG. 5 and FIG. 4 simultaneously in the following to understand the shutdown process of the system.

Firstly, a shutdown signal is given to the liquid fuel cell system 400 as shown in step 500. The shutdown signal is, for example, a shutdown signal initiated by a user.

In step 502, when the liquid fuel cell 402 receives the shutdown signal, the liquid fuel cell 402 stops discharging.

In step 504, the anode fuel supply device 408 stops supplying an anode fuel.

In step 506, the cathode gas supply device 404 stops supplying a cathode gas for a first duration. The first duration ranges, for example, from 5 s to 1 hr. The length of the first duration is related to the amount of the anode fuel remained. Generally, the more the anode fuel remains, the shorter the first duration is. A favorable range of the first duration ranges from 10 s to 30 min.

After the first duration, step 508 is performed to supply the cathode gas for a second duration which ranges from 3 s to 10 min, for instance. The length of the second duration is related to the flow rate of the cathode gas and the area of the cathode reaction. In general, the lower the flow rate of the cathode gas or the larger the area of the cathode reaction is, the longer the second duration is. A favorable range of the second duration ranges from 5 s to 5 min.

Afterwards, steps 506 to 508 are repeated. In a cycle of repeating steps 506 to 508, the first duration is a set value or a value varying with a temperature variation of the liquid fuel cell 402, wherein the temperature variation is a difference between an environmental temperature and a temperature of the liquid fuel cell 402. For example, the environmental temperature can be a constant and the temperature of the liquid fuel cell 402 can be a comparative parameter, and the first duration becomes longer as said difference between the temperatures becomes smaller.

Step 510 is performed when a temperature of the liquid fuel cell system 400 is lower than or equal to a third predetermined value or the cycle time of repeating steps 506 to 508 has reached a predetermined times. In step 510, the liquid fuel cell system 400 is stopped completely. The third predetermined value is 3° C.-10° C. higher than the environmental temperature, for example, and favorably 5° C. The predetermined number of times ranges from 1 to 20 times. The predetermined number of times favorably ranges from 1 to 12 times; however, the disclosure is not limited thereto.

In summary, the liquid fuel cell system of the disclosure is capable of supplying and stopping supplying the cathode gas repetitively after being shut down actively or passively. Accordingly, the remaining methanol crossed over to the cathode can be consumed through a combustion reaction so as to prevent the remaining fuel from affecting the membrane electrode set. Moreover, when the disclosure is applied in a passive liquid fuel cell system, the remaining fuel at the anode can be consumed completely, where the disclosure can discharge intermittently to enhance the fuel utilization rate.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A shutdown and self-maintenance operation process of a liquid fuel cell system, comprising:
the liquid fuel cell system giving a shutdown signal;
a liquid fuel cell of the liquid fuel cell system stopping discharging when receiving the shutdown signal;
a. the liquid fuel cell system stopping supplying a cathode gas;
b. after a first duration, the liquid fuel cell system starting supplying the cathode gas;
c. the liquid fuel cell starting discharging until an output power of the liquid fuel cell is less than or equal to a first predetermined value;
d. the liquid fuel cell stopping discharging and the liquid fuel cell system stopping supplying the cathode gas,
wherein a duration between starting supplying the cathode gas at step b and stopping supplying the cathode gas at step d is a second duration;
repeating steps a to d; and
stopping the liquid fuel cell system completely.

2. The shutdown and self-maintenance operation process of the liquid fuel cell system as claimed in claim 1, wherein the first predetermined value is a power consumption of the liquid fuel cell system.

3. The shutdown and self-maintenance operation process of the liquid fuel cell system as claimed in claim 1, wherein the first duration ranges from 5 seconds (s) to 1 hour (hr).

4. The shutdown and self-maintenance operation process of the liquid fuel cell system as claimed in claim 1, wherein the first duration is a constant.

5. The shutdown and self-maintenance operation process of the liquid fuel cell system as claimed in claim 1, wherein when repeating steps a to d, the first duration changes according to a temperature variation of the liquid fuel cell.

6. The shutdown and self-maintenance operation process of the liquid fuel cell system as claimed in claim 5, wherein the temperature variation is a difference between an environmental temperature and a temperature of the liquid fuel cell, and the first duration becomes longer as the difference becomes smaller.

7. The shutdown and self-maintenance operation process of the liquid fuel cell system as claimed in claim 1, wherein when repeating steps a to d, the first duration changes according to an output power variation of the liquid fuel cell in the second duration.

8. The shutdown and self-maintenance operation process of the liquid fuel cell system as claimed in claim 7, wherein the output power variation is a difference obtained by deducting a power output in the previous second duration from a power output in the second duration, and the first duration becomes longer as the difference becomes smaller.

9. The shutdown and self-maintenance operation process of the liquid fuel cell system as claimed in claim 1, wherein steps a to d are repeated until a total output power of the liquid fuel cell in the second duration at step d is smaller than a second predetermined value.

10. The shutdown and self-maintenance operation process of the liquid fuel cell system as claimed in claim 9, wherein the second predetermined value comprises a total power consumption of the liquid fuel cell system in the first duration and the second duration.

11. The shutdown and self-maintenance operation process of the liquid fuel cell system as claimed in claim 1, wherein steps a to d are repeated until a cycle of repeating steps a to d has reached a predetermined times.

12. The shutdown and self-maintenance operation process of the liquid fuel cell system as claimed in claim 11, wherein the predetermined times range from 1 to 20 times.

13. A shutdown and self-maintenance operation process of a liquid fuel cell system, the process comprising:
giving a shutdown signal to the liquid fuel cell system;
when the liquid fuel cell system receives the shutdown signal, a liquid fuel cell of the liquid fuel cell system stopping discharging;
stopping supplying an anode fuel;
a. stopping supplying a cathode gas for a first duration;
b. supplying the cathode gas for a second duration;
repeating steps a to b; and
stopping the liquid fuel cell system completely.

14. The shutdown and self-maintenance operation process of the liquid fuel cell system as claimed in claim 13, wherein the first duration ranges from 5 s to 1 hr.

15. The shutdown and self-maintenance operation process of the liquid fuel cell system as claimed in claim 13, wherein the first duration is a constant.

16. The shutdown and self-maintenance operation process of the liquid fuel cell system as claimed in claim 13, wherein when repeating steps a to b, the first duration changes according to a temperature variation of the liquid fuel cell.

17. The shutdown and self-maintenance operation process of the liquid fuel cell system as claimed in claim 16, wherein the temperature variation is a difference between an environmental temperature and a temperature of the liquid fuel cell, and the first duration becomes longer as the difference becomes smaller.

18. The shutdown and self-maintenance operation process of the liquid fuel cell system as claimed in claim 13, wherein steps a to b are repeated until a temperature of the liquid fuel cell system is lower than a third predetermined value.

19. The shutdown and self-maintenance operation process of the liquid fuel cell system as claimed in claim 18, wherein the third predetermined value is 3° C.-10° C. higher than an environmental temperature.

20. The shutdown and self-maintenance operation process of the liquid fuel cell system as claimed in claim 13, wherein the second duration ranges from 3 s to 10 minutes (min).

21. The shutdown and self-maintenance operation process of the liquid fuel cell system as claimed in claim 13, wherein steps a to b are repeated until a cycle of repeating steps a to b has reached a predetermined times.

22. The shutdown and self-maintenance operation process of the liquid fuel cell system as claimed in claim 21, wherein the predetermined times range from 1 to 20 times.
